(19) United States
(12) Patent Application Publication
(10) Pub. No.: US 2012/0239542 A1
(43) Pub. Date: Sep. 20, 2012

(54) SYSTEMS AND METHODS FOR CAPTURING PAYMENT INFORMATION USING MOBILE DEVICES

(76) Inventors: Dan Richard Preston, Palo Alto, CA (US); Jose H. Mercado, JR., Cambridge, MA (US)

(21) Appl. No.: 13/423,737

(22) Filed: Mar. 19, 2012

Related U.S. Application Data
(60) Provisional application No. 61/453,797, filed on Mar. 17, 2011.

(51) Int. Cl. G06Q 40/00

(52) U.S. Cl. 705/35

(57) ABSTRACT

Purchase card data used in a financial transaction is captured during the transaction by obtaining an image of a purchase card associated with an individual via an image acquisition component of a mobile device. The purchase card is identified and a second image is created comprising substantially only a visual representation of the purchase card. Account information is identified that is associated with the purchase card in the second image and an application form on the mobile device is automatically populated with the identified account information thus facilitating the entry of additional account information into the application form. The information is stored on the mobile device for use in subsequent purchases.

### CROSS-REFERENCE TO RELATED APPLICATIONS

This application claims priority to and the benefit of U.S. provisional patent application with Ser. No. 61/453,797 filed on Mar. 17, 2011 entitled “Systems and Methods for Capturing Payment Information Using Mobile Devices.”

### TECHNICAL FIELD OF THE INVENTION

Various embodiments of the invention relate generally to methods and supporting systems for improving retail shopping, and more specifically to methods and systems for capturing payment information using the imaging capabilities of a mobile device.

### BACKGROUND

Retail merchants spend considerable time, money and effort to attract consumers to their physical stores. This is especially true during sales and holiday periods and when new products are being released. Each customer that enters a physical store represents potential revenue and profits of the merchant. As such, merchants have an incentive to process as many customer purchase transactions as possible during a given time frame in order to maximize sales.

A merchant's ability to convert the store visitors to paying customers is a key component to the success of the store. However, sales can be limited by the amount of time required to process customer purchases at the retail establishment's sales registers, the number of staff members available to assist the customers, and the complexity of the purchase process itself. Each customer purchase requires a certain nontrivial amount of time to complete; for example, in a credit card transaction, a customer places items to be purchased on the counter, a sales clerk scans each item and totals the cost on the register, the customer locates a credit card, the sales clerk swipes the credit card, the payment is processed, the customer signs a receipt, the sales clerk places the items in bags, and each of these actions takes time.

As a result, there is a limit to the number of customer purchases that can be completed per register, per unit of time in a retail establishment. If more than that number of customers are in the store and willing to make purchases, they may have to wait in line due to backlogs at the registers. This often results in lost sales, as customers become frustrated in line and decide to leave the store without making their purchases rather than wait in line. Point-of-sale backlogs can also reduce sales by causing fewer customers to be attracted to shop at the retail establishment. If customers anticipate frustrating experiences waiting in long register lines, some may decide against visiting the store in the first place. This can be a common occurrence especially at peak shopping times or during special sale events, for example during holiday seasons. Any means for reducing or eliminating these inconveniences for customers has a direct, measurable positive impact on a stores bottom line.

Recently, advances in mobile technology have enhanced in-store shopping activities by allowing consumers to purchase items in real-time. For example, consumers now have access to applications (“apps”) on mobile devices such as cell phones and personal data assistants that facilitate the identification and purchase of items without physical presentation of the item to a point-of-sale terminal. So-called “scan and buy” apps encourage impulse purchases and streamline the buying process.

### SUMMARY OF THE INVENTION

Using the techniques and systems described herein, consumers are able to utilize a mobile application (an “app”) to make in-store purchases. As part of the process, the app is able to automatically capture and store the customers credit card information for subsequent use in a transaction. Unlike conventional online or mobile shopping experiences in which a consumer must manually enter a credit card number (and, in some cases additional information) this step of reading and entering up to sixteen numbers is automated, and the number is stored for subsequent use. For example, a consumer decide to make an in store purchase and initiate an app to complete the purchase without having to visit the point-of-sale counter. The app includes functionality that utilizes the camera within the consumer's mobile device to take a “picture” of her credit card and extract the relevant information therefrom. The relevant data may include the account number, the consumer's name, an expiration date, as well as other information. Additional data may be added manually (e.g., a PIN, a security code, billing address, phone number, etc.) to complete the card information profile. The card may be a credit card, bank card, debit card, gift card, or form of other stored-value card. The consumer may then pick up and scan an item using her mobile device to learn more information about the product (price, warranty, ratings, delivery costs and options, etc.) and decide to purchase the product.

In a first aspect a method of capturing purchase card data to be used in a financial transaction includes obtaining a first image comprising a purchase card associated with an individual via an image acquisition component operatively connected to a mobile device. The card is identified in the image and a second image is created that includes substantially only a visual representation of the purchase card. Account information is identified and read off of the second image and used to automatically populate an application form on the mobile device. Additional account information may be added to the form, and the captured and entered information is stored on the mobile device for subsequent transactions.

In some embodiments, the account information is paired with product data which represents products being purchased by the individual using the mobile device. The paired information may then me transmitted to an authentication server to authorize or deny the transaction.

In another aspect, a system for capturing event data resulting from a consumer's behavior at a retail establishment includes a mobile device having at least one processor. The processor is configured to execute stored instructions which may, in some cases be stored on the mobile device. The instructions, when executed, obtain a first image comprising a payment card via an image acquisition component on the mobile device and identify the purchase card in the first image. The instructions further cause a second image comprising substantially only an image of the payment card to be generated based on the first image, and from which account information associated with the payment card is identified. An application form on the mobile device is automatically populated with the identified account information, and additional account information may also be entered into the application form. The identified and entered information may then be stored on the mobile device for use in subsequent purchases.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram illustrating a system for capturing, storing and processing purchase card data using a mobile device in accordance with various embodiments of the invention.

FIG. 2 is a block diagram illustrating a mobile device application screen capturing purchase card information in accordance with various embodiments of the invention.

FIG. 3 is a flow chart illustrating a process for capturing purchase card data using a mobile device in accordance with various embodiments of the invention.

FIG. 4 is a block diagram illustrating one possible architecture for a mobile device in accordance with various embodiments of the invention.

### DETAILED DESCRIPTION

The inventors have recognized and appreciated that the use of personal, mobile devices as substitutes for traditional point-of-sale (“POS”) apparatuses provides numerous opportunities to enhance the “in-store” shopping experience for consumers and merchants by streamlining the purchase process and reducing overhead. For example, a consumer may select, view, touch, listen to, or otherwise interact with a product in the store, and decide to purchase it on the spot without having to wait for a customer service representative or waiting in line. The use of comprehensive and section “mobile checkout” applications (“apps”) makes this possible by providing item identification and electronic checkout processes directly to the consumer. In many cases, the consumer will complete the transaction using a type of payment card, whether that be a credit card, charge card, debit card, gift card, or other type of uniquely identifiable stored value card. In such cases, the consumer will need to input or otherwise provide her payment information to the app, either for each purchase, or, in some cases, as a one time entry that is then stored for subsequent purchases. The entry of this information takes time and is also prone to error.

Various embodiments of the invention related to methods and systems for enabling the capture and identification of payment information for both in-store and remote purchases. While specific examples may vary, certain implementations may be included as features in an application that may be downloaded to or come as a native application on a consumer mobile device that enables consumers to consider and complete mobile purchases.

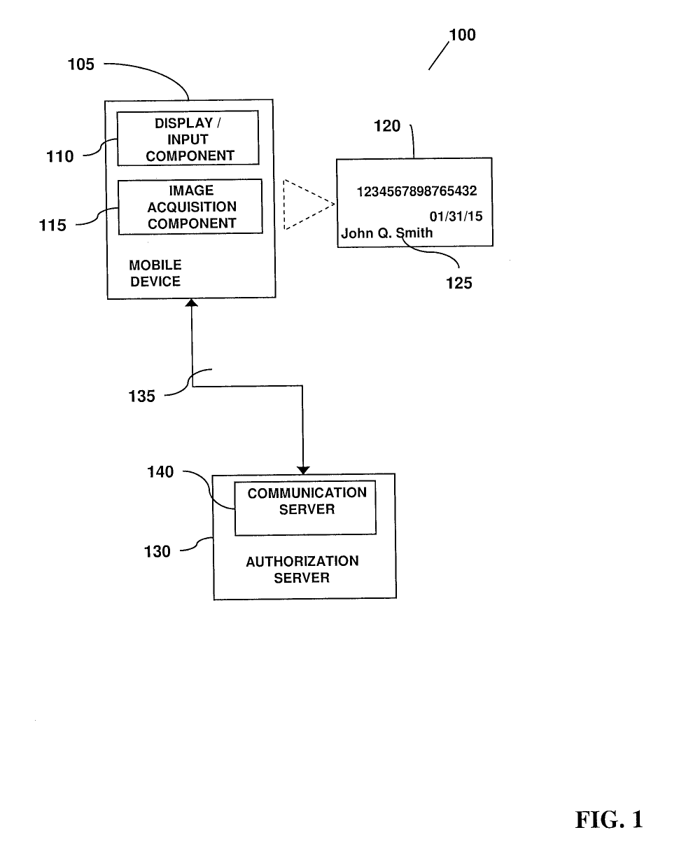

FIG. 1 illustrates an exemplary operating environment 100 in which a mobile device 105 (e.g., a mobile telephone, personal digital assistant, smartphone, or other handheld device such as an iPhone or Android-based device) may be used to purchase a product from a retail establishment, in accordance with some embodiments of the present disclosure. Mobile device 105 may be any mobile device having a processing capability, such as a cellular phone or a personal digital assistant (PDA). Mobile device 105 may be operatively connected to an image acquisition component 115, for example a camera integrated into the mobile device 105. Image acquisition component 115 may be any device component capable of capturing an image that includes a payment card 120 and information 125 on the face and/or back of the card 120. Such information 125 may include, for example, an account number, a name, an expiration date, a security code, a bank name, as well as other information that helps identify and authenticate the consumer and the payment card 120. The image acquisition component 115 also includes optical character recognition capabilities, such that the card information 125 or other text-based information may be read, digitally represented, and used in accordance with various implementations of the invention.

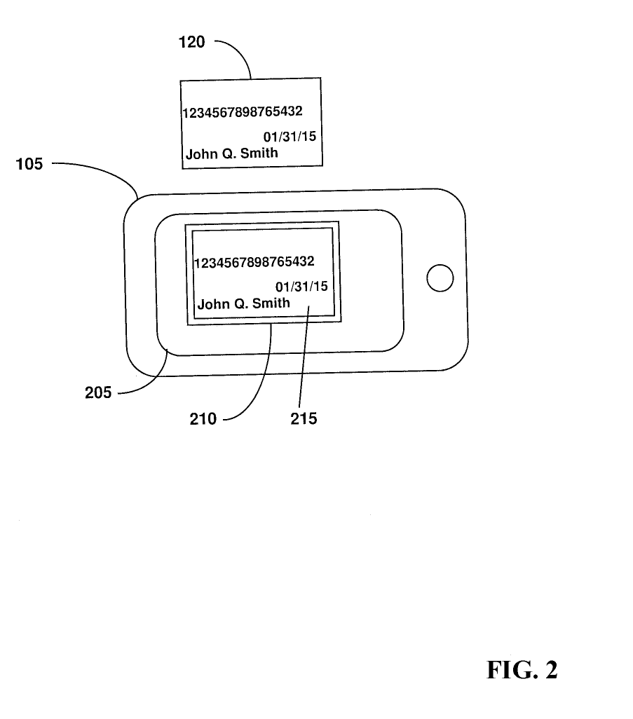

When a user of mobile device 105 intends to purchase a product in a retail establishment, the user may use the image acquisition component 115 of the mobile device 105 to obtain an image that includes the consumer's credit card 120. Referring to FIG. 2, the mobile device 105 includes a display 205 as the primary means for displaying information to and capturing input from the consumer. In certain embodiments, the device operates an app to facilitate the mobile purchase of goods, and the app presents a “frame” 210 on the display 205. The consumer manipulates the device 105 and/or the card 120 such that an image 215 of the card 120 appears within the frame 210. In some instances, the image 215 may include additional objects, such as background images, the consumer's hand, etc. The consumer then instructs the mobile device 105 to capture the image 215 once the payment card is substantially aligned inside the frame 210. Using the frame, the consumer can minimize the amount of background and other unnecessary objects are in the image. In some cases, the card is oriented a certain way (e.g., landscape relative to the phone) whereas in other cases the orientation of the phone relative to the card is not important. The user may, in some cases, enter additional information such as their name, a PIN or security code and/or a password using a keypad or touchscreen on the mobile device.

Referring back to FIG. 1, the mobile device 105 may transmit the card information and authorization data to an authentication server 130 to confirm and store the payment card information. Once the authentication server 130 determines the information is correct, an acknowledgement may be sent back to the mobile device 105. The mobile device 105 and authentication server 130 communicate with each other (as well as other devices and data sources) via a network 135. The network communication may take place via any media such as standard and/or cellular telephone lines, LAN or WAN links (e.g., T1, T3, 56kb, X.25), broadband connections (ISDN, Frame Relay, ATM), wireless links, and so on. Preferably, the network 135 can carry TCP/IP protocol communications, and HTTP/HTTPS requests made by the mobile device and the connection between the mobile device 105 and the server 130 can be communicated over such networks. In some implementations, the network includes various cellular data networks such as 2G, 3G, 4G, and others. The type of network is not limited, however, and any suitable network may be used. Typical examples of networks that can serve as the communications network 135 include a wireless or wired Ethernet-based intranet, a local or wide-area network (LAN or WAN), and/or the global communications network known as the Internet, which may accommodate many different communications media and protocols.

The authentication server 130 many include a communications server 140 that provides the conduit through which requests for data and processing are received from the mobile device 105, as well as interaction with other servers that may provide additional product information such as credit card information, user data, and other information.

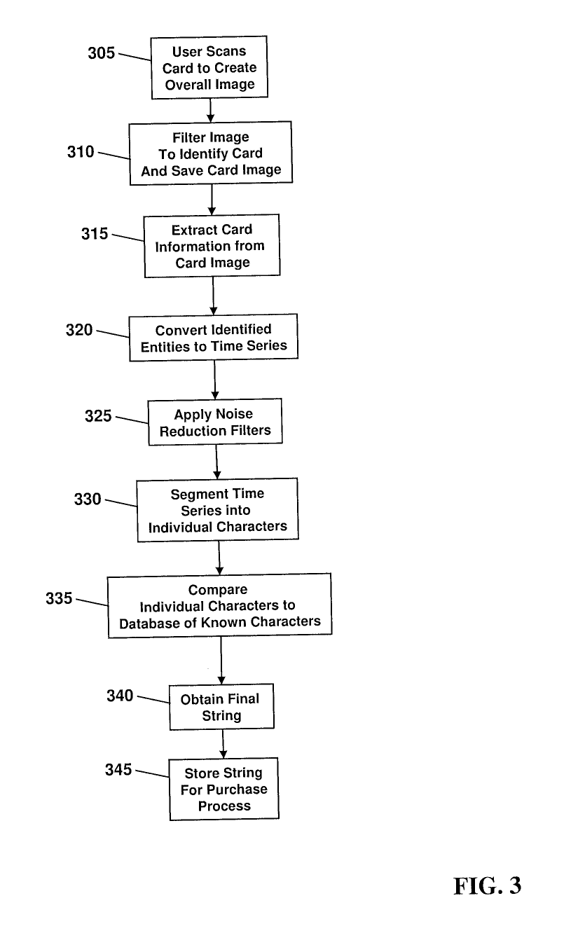

FIG. 3 is a flowchart illustrating a process for capturing payment card information using a mobile device, in accordance with some embodiments of the present disclosure. A user interested in making a purchase initiates an application on her mobile device 105 that includes an image capture component, typically a camera. The user scans the card (STEP 305) to create an overall image. The overall image may include background images (e.g., a floor, a table, the user's hand, images from the store, etc.) in addition to the payment card. A filtering step is then performed on the overall image (STEP 310). In some instances, this filtering process may include sharpening the image, noise reduction, color extraction, color filtering or other techniques to obtain a more accurate image. The filtering step may also include edge and/or line detection (using, for example, gradient magnitude techniques, thresholding, differential edge detection and others) to extract a card image from the overall image.

Once the card image has been identified, the card information is extracted from the card image (STEP 315). To determine the specific characters and values of the card information, one or more character recognition techniques may be applied to the card image. For example, pixels may be added along columns and rows in the image and the individual entities in the image (the as yet unidentified characters) are converted to a time-based series of pixel strengths (STEP 320). Additional noise reduction filters may be applied (STEP 325) to remove trends from the time series, and segmented (STEP 330) into individual character elements. Each character element is then compared to a library of known characters to identify the individual letters, numbers and symbols that comprise the card information (STEP 335). A final string (or, in some cases strings) are obtained (STEP 340) and stored for subsequent purchases (STEP 345). In some instances, the card information is securely transmitted (using, for example SSL encryption) to a remote server (which may be the same as the authentication server) and stored thereon. When the consumer wishes to make subsequent purchases using the same card, the mobile application transmits a request for the card information to the server, receives the card information, and populates the requisite forms. In other instances, the card information may be stored on the mobile devices (e.g., as cached data) for repeat purchases. The cached data may persist on the device after the app is no longer in use, or, in other instances, be deleted from memory after the application is closed.

In some instances, the card information is used to automatically populate a form (e.g., a check form for purchasing items) such that the consumer does not have to enter her credit card account number when making a purchase. Additional information (e.g., her PIN, a security code, etc.) may be manually entered on the same form or a separate form. The card information may then be paired with product information and used to complete a purchase. In certain embodiments, the card capture and identification techniques described herein may be used in conjunction with one or more remote product identification and purchasing applications to completely replace the traditional point-of-sale process, this significantly increasing a merchant's ability to service in-store customers. In such cases, a consumer may use similar image capture and recognition techniques to scan products (e.g., names, UPC codes, SKUs, model numbers, etc.) and create an electronic shopping card on their mobile device. Once done, the consumer scans her credit card and completes the purchase process.

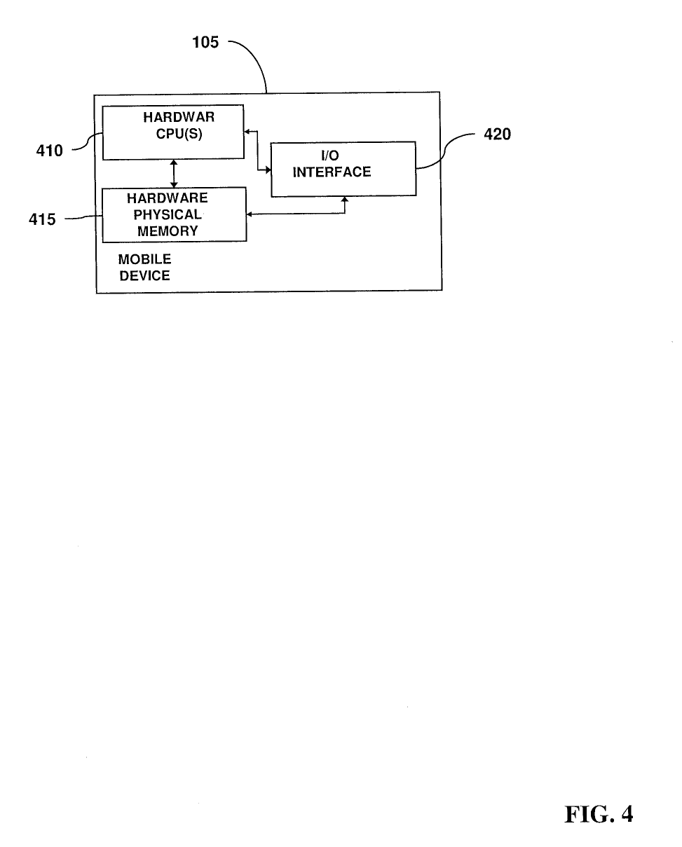

The mobile device 105 may be implemented in any suitable way. FIG. 4 illustrates one possible architecture for a mobile device 105 that may be used in some embodiments. The mobile device 105 may include hardware central processing unit(s) (CPU) 410, operatively connected to hardware/physical memory 415 and input/output (IO) interface 420.

An exemplary mobile device 105 may have one or more input and output devices. These devices can be used, among other things, to present a user interface and/or communicate (e.g., via a network) with other devices or computers. Examples of output devices that can be used to provide a user interface include printers or display screens for visual presentation of output, speakers or other sound generating devices for audible presentation of output, physical ports for implementing wired connections between the mobile device and other devices, and antennas for implementing wireless connections. Examples of input devices that can be used for a user interface include keyboards, and pointing devices, such as mice, touch pads, and digitizing tablets. As another example, a computer may receive input information through speech recognition or in other audible format.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only. The above-described embodiments of the present invention can be implemented in any of numerous ways. For example, the embodiments may be implemented using hardware, software or a combination thereof. When implemented in software, the software code can be executed on any suitable processor or collection of processors on the mobile device.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer-readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed by one or more processors, perform methods that implement the various embodiments of the invention discussed above. The computer readable medium or media can be transportable, such that the program or programs stored thereon can be downloaded onto one or more different mobile devices to implement various aspects of the present invention as discussed above. The terms “program” or “software” are used herein in a generic sense to refer to any type of computer code or set of computer-executable instructions that can be employed to instruct a computer or other processor to implement various aspects of the present invention as discussed above. Additionally, it should be appreciated that according to one aspect of this embodiment, one or more computer programs that when executed perform methods of the present invention need not reside on a single device or processor, but may be distributed in a modular fashion amongst a number of different devices or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In some embodiments the functions may be implemented as computer instructions stored in portions of a computer's random access memory to provide control logic that affects the processes described above. In such an embodiment, the program may be written in any one of a number of high-level languages, such as FORTRAN, PASCAL, C, C++, C#, Java, javascript, Tcl, or BASIC. Further, the program can be written in a script, macro, or functionality embedded in commercially available software, such as EXCEL or VISUAL BASIC. Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

Variations, modifications, and other implementations of what is described herein will occur to those of ordinary skill in the art without departing from the spirit and the scope of the invention as claimed.

1. A method of capturing purchase card data to be used in a financial transaction, the method comprising:
obtaining, via an image acquisition component operatively connected to a mobile device, a first image comprising a purchase card associated with an individual;
identifying the purchase card in the image and creating a second image comprising substantially only a visual representation of the purchase card;
identifying account information associated with the purchase card in the second image;
automatically populating an application form on the mobile device with the identified account information;
facilitating the entry of additional account information into the application form; and
storing the identified and stored account information on the mobile device for use in subsequent purchases.

2. The method of claim 1 further comprising pairing the account information with product data, the product data representing one or more products being purchased by the individual.

3. The method of claim 2 further comprising transmitting the paired account and product information to an authentication server.

4. A system for capturing event data resulting from a consumer's behavior at a retail establishment, the system comprising a mobile device having at least one processor configured to:
obtain, via an image acquisition component a first image comprising a payment card;
identify the purchase card in the first image and store a second image comprising substantially only an image of the payment card;
identify account information associated with the payment card from the second image;
automatically populating an application form on the mobile device with the identified account information;
facilitating the entry of additional account information into the application form; and
storing the identified and stored account information on the mobile device for use in subsequent purchases.

5. An article of manufacture having computer-readable program portions embodied thereon for capturing payment card information using a mobile device, the article comprising computer-readable instructions for:
obtaining, via an image acquisition component operatively connected to the mobile device, a first image comprising a purchase card associated with an individual;
identifying the purchase card in the image and creating a second image comprising substantially only a visual representation of the purchase card;
identifying account information associated with the purchase card in the second image;
automatically populating an application form on the mobile device with the identified account information;
facilitating the entry of additional account information into the application form; and
storing the identified and stored account information on the mobile device for use in subsequent purchases.
